(19) United States
(12) Patent Application Publication
(10) Pub. No.: US 2022/0258772 A1
(43) Pub. Date: Aug. 18, 2022

(54) VEHICLE CONTROL APPARATUS

(71) Applicant: Honda Motor Co., Ltd., Tokyo (JP)

(72) Inventor: Tokitomo Ariyoshi, Wako-shi (JP)

(21) Appl. No.: 17/592,465

(22) Filed: Feb. 3, 2022

(30) Foreign Application Priority Data
Feb. 15, 2021 (JP) 2021-021415

(51) Int. Cl. B60W 60/00; B60W 50/14; G06V 20/58

(52) U.S. Cl. CPC B60W 60/00184; B60W 60/0017; B60W 50/14; B60W 2420/42; G06V 20/584; B60W 2554/4029; G06V 20/582

(57) ABSTRACT

A vehicle control apparatus including a detection part configured to detect an external situation around a subject vehicle, and an electronic control unit including a microprocessor and a memory connected to the microprocessor. The microprocessor is configured to perform generating a map around the subject vehicle, based on an information on the external situation detected by the detection part, acquiring a travel information of the subject vehicle, extracting a specific information from among the travel information, adding the specific information to a landmark on the map, the landmark being a point on the map where the specific information has been obtained, and assisting in a driving based on the specific information added to the landmark.

### CROSS-REFERENCE TO RELATED APPLICATION

This application is based upon and claims the benefit of priority from Japanese Patent Application No. 2021-021415 filed on Feb. 15, 2021, the content of which is incorporated herein by reference.

### BACKGROUND OF THE INVENTION

### Field of the Invention

This invention relates to a vehicle control apparatus configured to control a vehicle so as to assist a safe driving.

### Description of the Related Art

As this type of apparatus, conventionally, there is a known apparatus which is configured to recognize a situation around a vehicle from a captured image obtained by imaging an environment around the vehicle, determine whether or not there is a risk factor in the environment around the vehicle based on the recognized surrounding situation, and output the determination results. Such a device is disclosed, for example, in Japanese Unexamined Patent Publication No. 2018-173861 (JP2018-173861A). The apparatus described in JP2018-173861A determines whether or not there is a risk factor in the environment around the vehicle by determining whether or not the risk factor in the similar surrounding situation occurred in the past.

However, there is not always a similar risk factor even in the similar surrounding situation, and thus there is a possibility that the apparatus described in JP2018-173861A cannot perform driving control of the vehicle that deals with the actual risk factor.

### SUMMARY OF THE INVENTION

An aspect of the present invention is a vehicle control apparatus including a detection part configured to detect an external situation around a subject vehicle, and an electronic control unit including a microprocessor and a memory connected to the microprocessor. The microprocessor is configured to perform generating a map around the subject vehicle, based on an information on the external situation detected by the detection part, acquiring a travel information of the subject vehicle, extracting a specific information from among the travel information, adding the specific information to a landmark on the map, the landmark being a point on the map where the specific information has been obtained, and assisting in a driving based on the specific information added to the landmark.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a vehicle control system having a vehicle control apparatus according to an embodiment of the present invention;

FIG. 2 is a view illustrating an example of a traveling scene to which the vehicle control apparatus according to the embodiment of the invention is applied;

FIG. 3 is a block diagram illustrating a configuration of a substantial part of the vehicle control apparatus according to the embodiment of the invention;

FIG. 4 is a flowchart illustrating an example of processing executed by a controller in FIG. 3; and

FIG. 5 is a view illustrating an example of a driving assist in a manual drive mode.

### DETAILED DESCRIPTION OF THE INVENTION

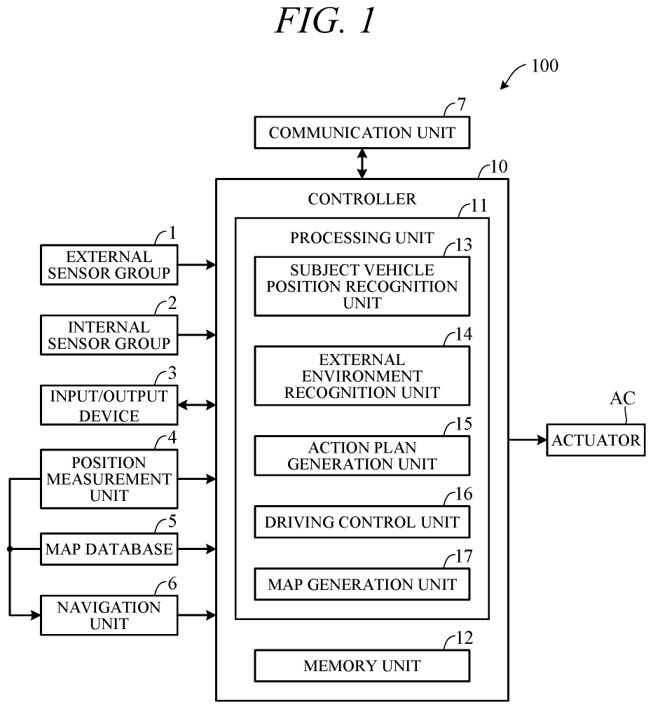

Hereinafter, an embodiment of the present invention is explained with reference to FIGS. 1 to 5. A vehicle control apparatus according to an embodiment of the invention can be applied to a vehicle having a self-driving capability, i.e., a self-driving vehicle. The self-driving vehicle having the vehicle control apparatus may be sometimes called “subject vehicle” to differentiate it from other vehicles. The subject vehicle is an engine vehicle having an internal combustion engine (engine) as a travel drive source, electric vehicle having a travel motor as the travel drive source, or hybrid vehicle having both of the engine and the travel motor as the travel drive source. The subject vehicle can travel not only in a self-drive mode in which a driving operation by a driver is unnecessary, but also in a manual drive mode in which the driving operation by the driver is necessary.

First, the general configuration of the subject vehicle for self-driving will be explained. FIG. 1 is a block diagram schematically illustrating an overall configuration of a vehicle control system 100 of the subject vehicle having the vehicle control apparatus according to an embodiment of the present invention. As shown in FIG. 1, the vehicle control system 100 mainly includes a controller 10, and an external sensor group 1, an internal sensor group 2, an input/output device 3, a position measurement unit 4, a map database 5, a navigation unit 6, a communication unit 7 and actuators AC which are communicably connected with the controller 10.

The term external sensor group 1 herein is a collective designation encompassing multiple sensors (external sensors) for detecting external circumstances constituting subject vehicle ambience data. For example, the external sensor group 1 includes, inter alia, a LIDAR (Light Detection and Ranging) for measuring distance from the subject vehicle to ambient obstacles by measuring scattered light produced by laser light radiated from the subject vehicle in every direction, a RADAR (Radio Detection and Ranging) for detecting other vehicles and obstacles around the subject vehicle by radiating electromagnetic waves and detecting reflected waves, and a CCD, CMOS or other image sensor-equipped on-board cameras for imaging subject vehicle ambience (forward, reward and sideways).

The term internal sensor group 2 herein is a collective designation encompassing multiple sensors (internal sensors) for detecting driving state of the subject vehicle. For example, the internal sensor group 2 includes, inter alia, a vehicle speed sensor for detecting vehicle speed of the subject vehicle, acceleration sensors for detecting forward-rearward direction acceleration and lateral acceleration of the subject vehicle, respectively, rotational speed sensor for detecting rotational speed of the travel drive source, a yaw rate sensor for detecting rotation angle speed around a vertical axis passing center of gravity of the subject vehicle and the like. The internal sensor group 2 also includes sensors for detecting driver driving operations in manual drive mode, including, for example, accelerator pedal operations, brake pedal operations, steering wheel operations and the like.

The term input/output device 3 is used herein as a collective designation encompassing apparatuses receiving instructions input by the driver and outputting information to the driver. The input/output device 3 includes, inter alia, switches which the driver uses to input various instructions, a microphone which the driver uses to input voice instructions, a display for presenting information to the driver via displayed images, and a speaker for presenting information to the driver by voice.

The position measurement unit (GNSS unit) 4 includes a position measurement sensor for receiving signal from positioning satellites to measure the location of the subject vehicle. The positioning satellites are satellites such as GPS satellites and Quasi-Zenith satellite. The position measurement unit 4 measures absolute position (latitude, longitude and the like) of the subject vehicle based on signal received by the position measurement sensor.

The map database 5 is a unit storing general map data used by the navigation unit 6 and is, for example, implemented using a hard disk or semiconductor element. The map data include road position data and road shape (curvature etc.) data, along with intersection and road branch position data. The map data stored in the map database 5 are different from high-accuracy map data stored in a memory unit 12 of the controller 10.

The navigation unit 6 retrieves target road routes to destinations input by the driver and performs guidance along selected target routes. Destination input and target route guidance is performed through the input/output device 3. Target routes are computed based on current position of the subject vehicle measured by the position measurement unit 4 and map data stored in the map database 35. The current position of the subject vehicle can be measured, using the values detected by the external sensor group 1, and on the basis of this current position and high-accuracy map data stored in the memory unit 12, target route may be calculated.

The communication unit 7 communicates through networks including the Internet and other wireless communication networks to access servers (not shown in the drawings) to acquire map data, travel history information, traffic data and the like, periodically or at arbitrary times. In addition to acquiring travel history information, travel history information of the subject vehicle may be transmitted to the server via the communication unit 7. The networks include not only public wireless communications network, but also closed communications networks, such as wireless LAN, Wi-Fi and Bluetooth, which are established for a predetermined administrative area. Acquired map data are output to the map database 5 and/or memory unit 12 via the controller 10 to update their stored map data.

The actuators AC are actuators for traveling of the subject vehicle. If the travel drive source is the engine, the actuators AC include a throttle actuator for adjusting opening angle of the throttle valve of the engine (throttle opening angle). If the travel drive source is the travel motor, the actuators AC include the travel motor. The actuators AC also include a brake actuator for operating a braking device and turning actuator for turning the front wheels FW.

The controller 10 is constituted by an electronic control unit (ECU). More specifically, the controller 10 incorporates a computer including a CPU or other processing unit (a microprocessor) 51 for executing a processing in relation to travel control, the memory unit (a memory) 12 of RAM, ROM and the like, and an input/output interface or other peripheral circuits not shown in the drawings. In FIG. 1, the controller 10 is integrally configured by consolidating multiple function-differentiated ECUs such as an engine control ECU, a transmission control ECU and so on. Optionally, these ECUs can be individually provided.

The memory unit 12 stores high-accuracy detailed road map data (road map information). The road map information includes information on road position, information on road shape (curvature, etc.), information on gradient of the road, information on position of intersections and branches, information on the number of lanes, information on width of lane and the position of each lane (center position of lane and boundary line of lane), information on position of landmarks (traffic lights, signs, buildings, etc.) as a mark on the map, and information on the road surface profile such as unevennesses of the road surface, etc. The map information stored in the memory unit 12 includes map information (referred to as external map information) acquired from the outside of the subject vehicle through the communication unit 7, and map information (referred to as internal map information) created by the subject vehicle itself using the detection values of the external sensor group 1 or the detection values of the external sensor group 1 and the internal sensor group 2. The external map information is, for example, information of a map (called a cloud map) acquired through a cloud server, and the internal map information is information of a map (called an environmental map) consisting of point cloud data generated by mapping using a technique such as SLAM (Simultaneous Localization and Mapping). The external map information is shared by the subject vehicle and other vehicles, whereas the internal map information is unique map information of the subject vehicle (e.g., map information that the subject vehicle has alone).

The memory unit 12 also stores information such as programs for various controls, and thresholds used in the programs. Further, the memory unit 12 stores travel history information of the subject vehicle obtained by the internal sensor group 2 in association with the high-accuracy map information (e.g., information of the environmental map). The travel history information is information indicating in what mode the subject vehicle traveling by manual driving traveled on the road in the past, and information such as a vehicle speed, a degree of acceleration/deceleration, a start position and an end position of acceleration/deceleration, and a temporary stop position is stored as the travel history information in association with position information on the road. The travel history information is used when the action plan generation unit 15 generates an action plan.

As functional configurations in relation to mainly self-driving, the processing unit 11 includes a subject vehicle position recognition unit 13, an external environment recognition unit 14, an action plan generation unit 15, a driving control unit 16, and a map generation unit 17.

The subject vehicle position recognition unit 13 recognizes the position of the subject vehicle (subject vehicle position) on the map based on position information of the subject vehicle calculated by the position measurement unit 4 and map information stored in the map database 5. Optionally, the subject vehicle position can be recognized using map information stored in the memory unit 12 and ambience data of the subject vehicle detected by the external sensor group 1, whereby the subject vehicle position can be recognized with high accuracy. Optionally, when the subject vehicle position can be measured by sensors installed externally on the road or by the roadside, the subject vehicle position can be recognized with high accuracy by communicating with such sensors through the communication unit 7.

The external environment recognition unit 14 recognizes external circumstances around the subject vehicle based on signals from cameras, LIDERs, RADARs and the like of the external sensor group 1. For example, it recognizes position, speed and acceleration of nearby vehicles (forward vehicle or rearward vehicle) driving in the vicinity of the subject vehicle, position of vehicles stopped or parked in the vicinity of the subject vehicle, and position and state of other objects. Other objects include traffic signs, traffic lights, road division lines and stop lines, buildings, guardrails, power poles, commercial signs, pedestrians, bicycles, and the like. Recognized states of other objects include, for example, traffic light color (red, green or yellow) and moving speed and direction of pedestrians and bicycles. A part of a stationary object among other objects, constitutes a landmark serving as an index of position on the map, and the external environment recognition unit 14 also recognizes the position and type of the landmark.

The action plan generation unit 15 generates a driving path (target path) of the subject vehicle from present time point to a certain time ahead based on, for example, a target route computed by the navigation unit 6, map information stored in the memory unit 12, subject vehicle position recognized by the subject vehicle position recognition unit 13, and external circumstances recognized by the external environment recognition unit 14. When multiple paths are available on the target route as target path candidates, the action plan generation unit 15 selects from among them the path that optimally satisfies legal compliance, safe efficient driving and other criteria, and defines the selected path as the target path. The action plan generation unit 15 then generates an action plan matched to the generated target path. An action plan is also called “travel plan”. The action plan generation unit 15 generates various kinds of action plans corresponding to overtake traveling for overtaking the forward vehicle, lane-change traveling to move from one traffic lane to another, following traveling to follow the preceding vehicle, lane-keep traveling to maintain same lane, deceleration or acceleration traveling. When generating a target path, the action plan generation unit 15 first decides a drive mode and generates the target path in line with the drive mode.

In self-drive mode, the driving control unit 16 controls the actuators AC to drive the subject vehicle along target path generated by the action plan generation unit 15. More specifically, the driving control unit 16 calculates required driving force for achieving the target accelerations of sequential unit times calculated by the action plan generation unit 15, taking running resistance caused by road gradient and the like into account. And the driving control unit 16 feedback-controls the actuators AC to bring actual acceleration detected by the internal sensor group 2, for example, into coincidence with target acceleration. In other words, the driving control unit 16 controls the actuators AC so that the subject vehicle travels at target speed and target acceleration. On the other hand, in manual drive mode, the driving control unit 16 controls the actuators AC in accordance with driving instructions by the driver (steering operation and the like) acquired from the internal sensor group 2.

The map generation unit 17 generates the environment map constituted by three-dimensional point cloud data using detection values detected by the external sensor group 1 during traveling in the manual drive mode. Specifically, an edge indicating an outline of an object is extracted from a camera image acquired by the camera based on luminance and color information for each pixel, and a feature point is extracted using the edge information. The feature point is, for example, an intersection of the edges, and corresponds to a corner of a building, a corner of a road sign, or the like. The map generation unit 17 sequentially plots the extracted feature point on the environment map, thereby generating the environment map around the road on which the subject vehicle has traveled. The environment map may be generated by extracting the feature point of an object around the subject vehicle using data acquired by radar or LIDAR instead of the camera.

The subject vehicle position recognition unit 13 performs subject vehicle position estimation processing in parallel with map creation processing by the map generation unit 17. That is, the position of the subject vehicle is estimated based on a change in the position of the feature point over time. The map creation processing and the position estimation processing are simultaneously performed, for example, according to an algorithm of SLAM. The map generation unit 17 can generate the environment map not only when the vehicle travels in the manual drive mode but also when the vehicle travels in the self-drive mode. If the environment map has already been generated and stored in the memory unit 12, the map generation unit 17 may update the environment map with a newly obtained feature point.

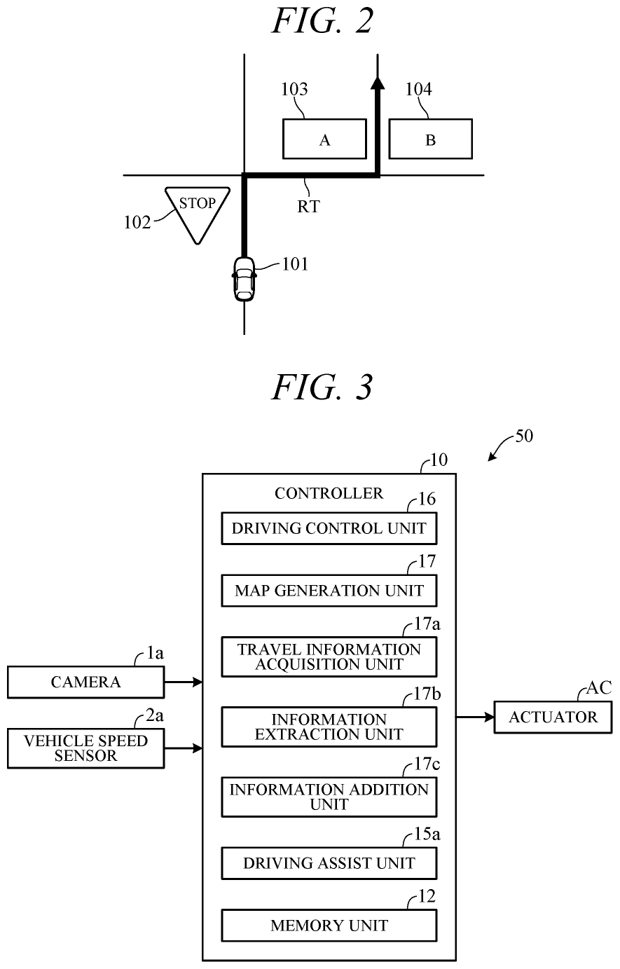

The characteristic configuration of the vehicle control apparatus according to the present embodiment will be described. FIG. 2 is a view illustrating an example of a traveling scene to which a vehicle control apparatus 50 is applied. In the example in FIG. 2, the subject vehicle 101 moves along a route RT indicated by a thick arrow on a road map. That is, the vehicle turns right at the intersection provided with a stop sign 102, passes in front of an “A” facility 103, then turns left, and travels between the A facility 103 and a B facility 104. The A facility 103 is a store such as a convenience store, and the B facility 104 is a school, for example.

In such a traveling scene, the subject vehicle 101 needs to travel particularly carefully when traveling around the intersection provided with the sign 102 and traveling around the A facility 103 and the B facility 104 (for example, between the A facility and the B facility). That is, the subject vehicle 101 needs to travel with an increased attention level to avoid a contact accident between the subject vehicle 101 and another vehicle, a pedestrian, or the like, and to suppress a sudden change in behavior of the subject vehicle 101 such as sudden braking or sudden steering due to the presence of the other vehicle or pedestrian. Hereinafter, a factor that causes the contact accident or the sudden change in behavior of the subject vehicle 101 is referred to as a risk factor. The risk factor is a factor of the risk latent in the road. When the vehicle travels at a location where a risk factor is present, it is necessary to increase the attention level (travel attention level) during traveling.

The risk factor is not uniformly determined by a road structure that is a geographical situation such as an intersection or a location of a facility, but changes depending on the situation of an individual road. In other words, even when the road structures of two roads are compared and the road structures are similar to each other, the risk factors latent in the roads are not necessarily the same. For this reason, in the configuration in which a cloud map to which information on the risk factor corresponding to the road structure is associated in advance is acquired from a cloud server and the vehicle travels in the self-drive mode based on the acquired cloud map, there is a possibility that appropriate traveling cannot be performed according to the individual road situation. In consideration of the possibility, the vehicle control apparatus is configured as follows in the present embodiment:

Hereinafter, in order to avoid a complicated description, the configuration of the vehicle control apparatus will be described on the assumption that the vehicle travels in the manual drive mode to generate an environment map, and then travels in the self-drive mode using the environment map. FIG. 3 is a block diagram illustrating a configuration of a substantial part of the vehicle control apparatus 50 according to the present embodiment. The vehicle control apparatus 50 constitutes a part of the vehicle control system 100 in FIG. 1. As illustrated in FIG. 3, the vehicle control apparatus 50 includes the controller 10, a camera 1a, a vehicle speed sensor 2a, and the actuator AC.

The camera 1a is a monocular camera having an imaging element (image sensor) such as a CCD or a CMOS, and constitutes a part of the external sensor group 1 in FIG. 1. The camera 1a may be a stereo camera. The camera 1a is mounted at a predetermined position, for example, in front of the subject vehicle 101, and continuously captures an image of a space in front of the subject vehicle 101 to acquire an image (camera image) of the object. The vehicle speed sensor 2a detects the vehicle speed of the subject vehicle 101. The vehicle speed sensor 2a constitutes a part of the internal sensor group 2 in FIG. 1.

The controller 10 includes a travel information acquisition unit 17a, an information extraction unit 17b, an information addition unit 17c, and a driving assist unit 15a as a functional configuration undertaken by the processing unit 11 (FIG. 1), in addition to the driving control unit 16 and the map generation unit 17. The travel information acquisition unit 17a, the information extraction unit 17b, and the information addition unit 17c have functions associated with the map generation unit 17. Therefore, these may also be included in the map generation unit 17. The driving assist unit 15a is constituted by, for example, the action plan generation unit 15 in FIG. 1.

The map generation unit 17 generates the environment map constituted by a map around the subject vehicle 101, that is, the environment map constituted by three-dimensional point group data, based on the camera image acquired by the camera 1a during traveling in the manual drive mode. The generated environment map is stored in the memory unit 12. When generating the environment map, the map generation unit 17 determines whether or not a landmark such as a traffic light, a sign, or a building as a mark on the map is included in the camera image by, for example, pattern matching processing. When it is determined that the landmark is included, the position and the type of the landmark on the environment map are recognized based on the camera image. The landmark information is included in the environment map and stored in the memory unit 12.

The travel information acquisition unit 17a acquires vehicle speed information of the subject vehicle 101 detected by the vehicle speed sensor 2a, for example, during travel in the manual drive mode. The vehicle speed information is predetermined travel information of the subject vehicle 101 correlated with the risk factor. That is, since the driver travels at a reduced speed when traveling in a place with the risk factor, the vehicle speed information is included in the predetermined travel information. Information on the operation of the brake may be acquired as the predetermined traveling information. The predetermined travel information correlated with the risk factor also includes information indicating the external situation around the subject vehicle 101. Therefore, the travel information acquisition unit 17a also acquires the camera image acquired by the camera 1a as the predetermined travel information. The predetermined travel information acquired by the travel information acquisition unit 17a is stored in the memory unit 12 in association with the map information at the point where the travel information has been obtained.

The information extraction unit 17b extracts specific information in which the presence of the risk factor is estimated from among the travel information (the vehicle speed information and the camera image) stored in the memory unit 12. The specific information is travel attention information requiring an increase in the travel attention level, and for example, information indicating temporary stop, information on sudden deceleration (a deceleration rate equal to or more than a predetermined value), and information on traveling at a low speed sufficiently lower than a legal speed (a speed equal to or less than a predetermined ratio of the legal speed) among the vehicle speed information stored in the memory unit 12 are extracted as the specific information. The specific information is obtained, for example, when the vehicle travels around the sign 102 or around the facilities 103,104 in FIG. 2. When the camera image stored in the memory unit 12 includes an image of a pedestrian or a bicycle crossing the road (for example, an image of the pedestrian or bicycle crossing the road without a traffic light), the information extraction unit 17b also extracts information of such a camera image (information indicating road crossing) as the specific information.

The information extraction unit 17b may be configured to extract the specific information based on information both on the vehicle speed and of the camera image. For example, when a pedestrian, a bicycle, or the like is included in the camera image and the vehicle speed decreases, it is assumed that a risk factor is present for the driver who performs manual driving. Therefore, the information on the vehicle speed and of the camera image at that time may be extracted as the specific information. This can increase the accuracy in estimating the presence of the risk factor.

The information addition unit 17c searches a landmark corresponding to the point where the specific information extracted by the information extraction unit 17b has been obtained, from among the landmarks included in the map information stored in the memory unit 12. For example, the sign 102 and the facilities 103 and 104 in FIG. 2 are searched as the landmark. Further, the information addition unit 17c adds the corresponding specific information extracted by the information extraction unit 17b to each of the searched landmarks. The landmark information to which the specific information has been added is stored in the memory unit 12 as a part of the map information.

The driving assist unit 15a generates the action plan based on the specific information added by information addition unit 17c during traveling in the self-drive mode, and performs driving assist based on the action plan. That is, the action plan is generated so that the traveling operation of the subject vehicle 101 is on the safe side when traveling on the road around the landmark to which the specific information has been added, as compared with when traveling on the road to which the specific information has not been added. For example, the action plan on the safer side is generated, such as generating a travel locus farther away from the sidewalk, decreasing the vehicle speed, or shifting the point of temporary stop to the nearer side.

The driving control unit 16 outputs a control signal to the actuator AC so that the subject vehicle 101 travels by self-driving according to the action plan generated by the driving assist unit 15a, which is a part of the action plan generation unit 15 (FIG. 1).

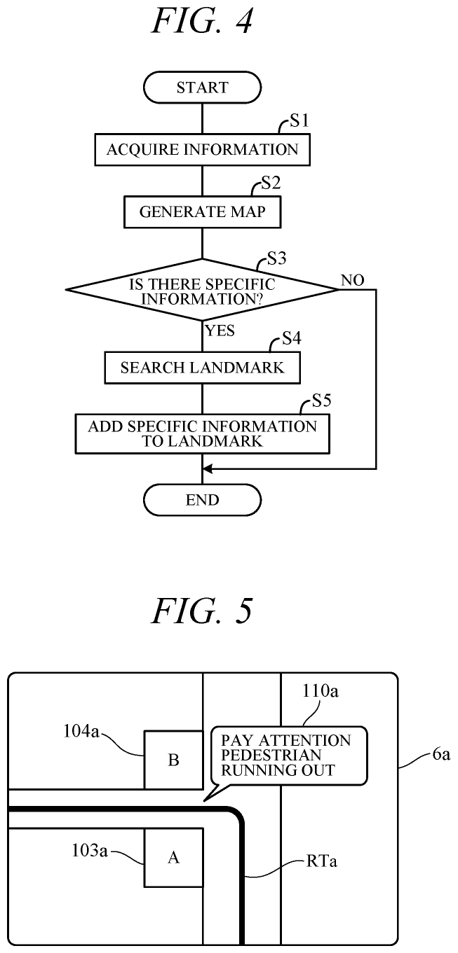

FIG. 4 is a flowchart illustrating an example of processing executed by the controller 10 in FIG. 3 according to a predetermined program, particularly an example of processing regarding map generation. The processing illustrated in this flowchart is started, for example, during traveling in the manual drive mode, and is repeated at a predetermined cycle while traveling in the manual drive mode continues.

As illustrated in FIG. 4, first in S1, information of a camera image obtained by the camera 1a and vehicle speed information obtained by the vehicle speed sensor 2a are acquired. Next, in S2, a map around the subject vehicle 101, that is, the environment map is generated based on the camera image acquired in S1, and the environment map is stored in the memory unit 12. At this time, when a landmark is recognized, the environment map is stored together with landmark information in association with the environment map. Next, in S3, it is determined whether or not the information of the camera image and the vehicle speed information acquired in S1 include specific information in which the presence of a risk factor is estimated, such as information on a pedestrian crossing the road and information on temporary stop of the subject vehicle 101. When a positive determination is made in S3, the processing proceeds to S4; when a negative determination is made, the processing ends.

In S4, a landmark around the point determined to have the specific information in S3 is searched from the map information stored in the memory unit 12. That is, the landmark corresponding to the specific information is searched. The map information in this case is the environment map generated and stored in S2 or the map information stored in advance in the memory unit 12, and these maps include landmark information in advance. Next, in S5, the corresponding specific information is added to the landmark searched in S4. Then, the landmark to which the specific information has been added is stored in the memory unit 12 as a part of the map information of the environment map, and the processing ends.

The operation of the vehicle control apparatus 50 according to the present embodiment will be described more specifically. For example, when the subject vehicle 101 travels in the manual drive mode along the route RT as illustrated in FIG. 2, the environment map is generated (S2). At this time, if there is a risk factor such as a pedestrian running out at the intersection ahead of the sign 102 or around the A facility 103 or the B facility 104, the driver travels at a reduced vehicle speed. The vehicle speed information at this time is a part of the predetermined travel information in which the presence of the risk factor is estimated. The specific information is added to the information on the landmark (the sign 102 and the facilities 103 and 104) around the point where the predetermined travel information has been obtained, and is stored in the memory unit 12 as a part of the map information of the environment map (S5). Similarly, when the presence of the risk factor is recognized from the camera image, the specific information is also added to the information on the surrounding landmark and stored.

Thereafter, when the vehicle travels by self-driving along the route RT using the environment map, that is, when the vehicle travels around the landmark to which the specific information has been added, the action plan generation unit 15 (the driving assist unit 15a) generates the action plan on the safe side as compared with when the vehicle travels around the landmark to which the specific information has not been added. Therefore, the subject vehicle 101 can travel by self-driving while recognizing the presence of the risk factor latent in the route RT in advance, and thus it is possible to realize appropriate self-driving travel with high safety according to the individual road situation.

An example in which driving assist is performed when the driving assist unit 15a generates the action plan that deals with the risk factor has been described above assuming traveling in the self-drive mode; however, the driving assist unit 15a also can perform driving assist during traveling in the manual drive mode. In this case, the configuration may be such that information for calling attention is reported to the driver when the vehicle travels around the landmark to which the specific information has been added. FIG. 5 is a view illustrating an example of the configuration. FIG. 5 illustrates an example of a display image on a display 6a of the navigation unit 6. Specifically, images 103a and 104a of the A facility 103 and the B facility 104, and an image RTa for route guidance are displayed, while an image 110a for calling attention such as a message saying “Pay attention to pedestrians running out” is displayed around the images 103a and 104a. This allows the driver to easily recognize the presence of the risk factor.

The present embodiment can achieve advantages and effects such as the following:

(1) The vehicle control apparatus 50 includes the camera 1a that detects the external situation of the subject vehicle 101, the map generation unit 17 that generates a map around the subject vehicle 101 based on information on the external situation detected by the camera 1a, the travel information acquisition unit 17a that acquires travel information of the subject vehicle 101 obtained by the camera 1a and the vehicle speed sensor 2a, the information extraction unit 17b that extracts specific information in which the presence of a risk factor is estimated from among the travel information acquired by the travel information acquisition unit 17a, the information addition unit 17c that adds the specific information to a landmark (the sign 102, the facilities 103 and 104, and the like) that is included in the map information generated by the map generation unit 17 and corresponds to a point where the specific information extracted by the information extraction unit 17b has been obtained, and the driving assist unit 15a that performs driving assist based on the specific information added by the information addition unit 17c (FIG. 3).

With this configuration, it is possible to perform driving assist with higher safety that deals with the presence of the actual risk factor. In addition, the way of grasping the risk factor may differ depending on the individual person, but since the way of grasping the risk factor is reflected in the travel information (the vehicle speed information or the like), it is possible to perform driving assist with a high satisfaction level for the individual person by performing driving assist based on the past travel information. Since the specific information in which the presence of the risk factor is estimated is added to the landmark, the presence of the risk factor can be grasped merely by determining whether or not the subject vehicle 101 travels near a predetermined landmark (the sign 102 and the facilities 103 and 104), so that the vehicle control apparatus 50 for performing driving assist can be easily configured.

(2) The travel information includes information on the external situation detected by the camera 1a when the subject vehicle 101 travels (FIG. 3). With this configuration, even when there is no change in the vehicle speed of the subject vehicle 101, it is possible to grasp the place where pedestrian running out or the like occurred recognized by the camera 1a as the place where the risk factor is present.

(3) The specific information corresponds to the travel attention information requiring an increase in the travel attention level. Therefore, it is possible to appropriately deal with the presence of the risk factor.

(4) The vehicle control apparatus 50 further includes the memory unit 12 that stores information on the landmark to which the specific information has been added, and the driving control unit 16 that controls the travel actuator AC mounted on the subject vehicle 101 so that the subject vehicle 101 travels by self-driving according to the action plan (FIG. 3). The driving assist unit 15a is configured to generate the action plan based on the specific information that has been added by the information addition unit 17c when the subject vehicle 101 travels around the landmark stored in the memory unit 12. With this configuration, it is possible to perform appropriate self-driving travel in consideration of safety based on the specific information obtained when traveling in the manual drive mode in advance.

(5) The vehicle control apparatus 50 further includes the memory unit 12 that stores information on the landmark to which specific information has been added. The driving assist unit 15a is configured to inform the driver of information for calling attention when the subject vehicle 101 travels around the landmark stored in the memory unit 12 (FIG. 5). With this configuration, it is possible to perform appropriate driving assist for the driver during traveling in the manual drive mode.

The above embodiment may be modified into various forms. Hereinafter, some modifications will be described. In the above embodiment, the external situation of the subject vehicle is detected by the external sensor group 1 such as the camera 1a; however, any configuration of a detection part may be used as long as the external situation is detected for map generation. In the above embodiment, the map generation unit 17 is configured to generate the environment map while the subject vehicle travels in the manual drive mode; however, the map generation unit 17 may be configured to generate the environment map while the subject vehicle travels in the self-drive mode. In the above embodiment, the vehicle speed information and the information of the camera image are acquired as the predetermined travel information; however, other travel information correlated with the specific information in which the presence of the risk factor is estimated may be acquired.

In the above embodiment, the specific information corresponding to the travel attention information requiring an increase in the travel attention level is extracted from among the travel information acquired by the travel information acquisition unit 17a; however, other specific information may be extracted. In the above embodiment, a sign, a building, and the like are used as the landmark included in the map information; however, when there is a place requiring attention during traveling even on a traveling route without a sign such as for temporary stop, such information (the traveling attention information) may be included in the map information as the landmark (a virtual landmark) and stored in the memory unit 12 during manual driving. Then, a warning may be issued in advance based on the traveling attention information during traveling in the self-drive mode, and the action plan may be generated so as to be on the safer side during traveling in the self-drive mode. Therefore, the landmark to which the specific information is added is not limited to the sign, the building, and the like. In the above embodiment, the landmark around the point where the specific information has been obtained is searched from the map information of the environment map; however, the landmark may be searched using a cloud map, and the searched landmark to which the specific information has been added may be stored as a part of the environment map.

In the above embodiment, the driving assist unit 15a is configured to generate the action plan on the safer side during traveling in the self-drive mode around the landmark to which the specific information has been added; however, the configuration of a driving assist unit is not limited to that described above. For example, the action plan may be generated so as to sufficiently increase the inter-vehicle distance when there is a preceding vehicle. The action plan may be generated so as to avoid traveling around the landmark to which the specific information has been added. In the above embodiment, the image for calling attention is displayed on the display 6a of the navigation unit 6 during traveling in the manual drive mode around the landmark to which the specific information has been added; however, the information for calling attention may be reported by voice or the like, for example.

The present invention can also be used as a vehicle control method including generating a map around a subject vehicle, based on an information on an external situation around the subject vehicle detected by a detection part such as a camera 1a, acquiring a travel information of the subject vehicle, extracting a specific information from among the travel information, adding the specific information to a landmark on the map, the landmark being a point on the map where the specific information has been obtained, and assisting in a driving based on the specific information added to the landmark.

The above embodiment can be combined as desired with one or more of the above modifications. The modifications can also be combined with one another.

According to the present invention, it is possible to perform a driving control of a vehicle corresponding to an actual risk factor.

Above, while the present invention has been described with reference to the preferred embodiments thereof, it will be understood, by those skilled in the art, that various changes and modifications may be made thereto without departing from the scope of the appended claims.

What is claimed is:

1. A vehicle control apparatus, comprising:
a detection part configured to detect an external situation around a subject vehicle; and
an electronic control unit including a microprocessor and a memory connected to the microprocessor, wherein
the microprocessor is configured to perform:
generating a map around the subject vehicle, based on an information on the external situation detected by the detection part;
acquiring a travel information of the subject vehicle;
extracting a specific information from among the travel information;
adding the specific information to a landmark on the map, the landmark being a point on the map where the specific information has been obtained; and
assisting in a driving based on the specific information added to the landmark.

2. The vehicle control apparatus according to claim 1, wherein
the travel information includes the information on the external situation detected by the detection part when the subject vehicle travels.

3. The vehicle control apparatus according to claim 1, wherein
the specific information is a travel attention information requiring an increase in a travel attention level.

4. The vehicle control apparatus according to claim 3, wherein
the memory is configured to store an information on the landmark to which the specific information has been added, and
the microprocessor is configured to perform
the assisting including informing a driver of the subject vehicle of an information to call an attention when the subject vehicle travels around the landmark sored in the memory.

5. The vehicle control apparatus according to claim 3, wherein
the memory is configured to store an information on the landmark to which the specific information has been added, and
the microprocessor is configured to further perform
controlling an actuator for traveling mounted on the subject vehicle so that the subject vehicle travels by a self-driving according to an action plan, and
the microprocessor is configured to perform
the assisting including generating the action plan based on the specific information added to the landmark when the subject vehicle travels around the landmark on which the information is stored in the memory.

6. The vehicle control apparatus according to claim 1, wherein
the microprocessor is configured to perform
the extracting including extracting the specific information from among the travel information obtained during a manual driving of the subject vehicle.

7. The vehicle control apparatus according to claim 1, wherein
the specific information is an information indicating a temporary stop, an information on traveling at a deceleration rate equal to or more than a predetermined level, or an information on traveling at a vehicle speed equal to or less than a predetermined ratio of a legal speed.

8. The vehicle control apparatus according to claim 1, wherein
the detection part is a camera, and
the specific information is an information on a pedestrian or bicycle crossing a road included in an image of the camera.

9. The vehicle control apparatus according to claim 1, wherein
the landmark is a traffic light, a sign, or a building.

10. A vehicle control method, comprising:
generating a map around a subject vehicle, based on an information on an external situation around the subject vehicle detected by a detection part;
acquiring a travel information of the subject vehicle;
extracting a specific information from among the travel information;
adding the specific information to a landmark on the map, the landmark being a point on the map where the specific information has been obtained; and
assisting in a driving based on the specific information added to the landmark.

11. The vehicle control method according to claim 10, wherein
the travel information includes the information on the external situation detected by the detection part when the subject vehicle travels.

12. The vehicle control method according to claim 10, wherein
the specific information is a travel attention information requiring an increase in a travel attention level.

13. The vehicle control method according to claim 12, further comprising
storing in a memory an information on the landmark to which the specific information has been added, wherein
the assisting includes informing a driver of the subject vehicle of an information to call an attention when the subject vehicle travels around the landmark sored in the memory.

14. The vehicle control method according to claim 12, further comprising:
storing an information on the landmark to which the specific information has been added; and
controlling an actuator for traveling mounted on the subject vehicle so that the subject vehicle travels by a self-driving according to an action plan, wherein
the assisting includes generating the action plan based on the specific information added to the landmark when the subject vehicle travels around the landmark on which the information is stored in the memory.

15. The vehicle control method according to claim 10, wherein
the extracting includes extracting the specific information from among the travel information obtained during a manual driving of the subject vehicle.

16. The vehicle control method according to claim 10, wherein
the specific information is an information indicating a temporary stop, an information on traveling at a deceleration rate equal to or more than a predetermined level, or an information on traveling at a vehicle speed equal to or less than a predetermined ratio of a legal speed.

17. The vehicle control method according to claim 10, wherein
the detection part is a camera, and
the specific information is an information on a pedestrian or bicycle crossing a road included in an image of the camera.

18. The vehicle control apparatus according to claim 10, wherein
the landmark is a traffic light, a sign, or a building.
